(19) United States
(12) Patent Application Publication
(10) Pub. No.: US 2018/0037714 A1
(43) Pub. Date: Feb. 8, 2018

(54) BORON-CONTAINING FABRICATED ARTICLE PREPARED FROM POLYOLEFIN PRECURSOR

(71) Applicant: Dow Global Technologies LLC, Midland, MI (US)

(72) Inventors: Eric J. Hukkanen, Essex, MA (US); Bryan E. Barton, Lincoln University, PA (US); Gerald F. Billovits, Midland, MI (US); Weijun Wang, Midland, MI (US); Jasson T. Patton, Midland, MI (US); Christopher W. Derstine, Midland, MI (US); Edoardo Nicoli, Midland, MI (US); Thomas H. Peterson, Midland, MI (US)

(73) Assignee: Dow Global Technologies LLC, Midland, MI (US)

(21) Appl. No.: 15/551,965

(22) PCT Filed: Apr. 7, 2016
(86) PCT No.: PCT/US2016/026462

§ 371 Date: Aug. 18, 2017

Related U.S. Application Data
(60) Provisional application No. 62/153,201, filed on Apr. 27, 2015.

(51) Int. Cl. C08K 3/38; D06M 13/51; D01F 1/10; D06M 11/80; C08K 5/55; D01F 6/04

(52) U.S. Cl. CPC C08K 3/38; C08K 5/55; D01F 6/04; D01F 1/10; D06M 11/80; D06M 13/51; D01F 9/21

(57) ABSTRACT

In one instance, the present disclosure describes a crosslinked polyolefin article comprising: a carbon to hydrogen mol ratio of from 1:1.2 to 1:2.2; and 0.1 to 5 weight percent boron. In one instance, the present disclosure describes a stabilized polyolefin article comprising: a carbon to hydrogen mol ratio of from 1:0.8 to 1:1.3; greater than 18 weight percent oxygen; and 0.3 to 4 weight percent boron.

### BACKGROUND

Previously, carbonaceous articles, such as carbon fibers, have been produced primarily from polyacrylonitrile (PAN), pitch, or cellulose precursors. The process for making carbonaceous articles begins by forming a fabricated article, such as a fiber or a film, from the precursor. Precursors may be formed into fabricated articles using standard techniques for forming or molding polymers. The fabricated article is subsequently stabilized to allow the fabricated article to substantially retain shape during the subsequent heat-processing steps; without being limited by theory, such stabilization typically involves a combination of oxidation and heat and generally results in dehydrogenation, ring formation, oxidation and crosslinking of the precursor which defines the fabricated article. The stabilized fabricated article is then converted into a carbonaceous article by heating the stabilized fabricated article in an inert atmosphere. While the general steps for producing a carbonaceous article are the same for the variety of precursors, the details of those steps vary widely depending on the chemical makeup of the selected precursor.

Polyolefins have been investigated as an alternative precursor for carbonaceous articles, but a suitable and economically viable preparation process has proven elusive. Of particular interest is identifying an economical process for preparing stabilized articles from polyolefin precursors which later may be formed into carbonaceous articles. For example, maximizing mass retention during the stabilization step is of interest.

### STATEMENT OF INVENTION

In one instance, the present disclosure describes a crosslinked polyolefin article comprising: a carbon to hydrogen mol ratio of from 1:1.2 to 1:2.2; and 0.1 to 5 weight percent boron. In one instance, the present disclosure describes a stabilized polyolefin article comprising: a carbon to hydrogen mol ratio of from 1:0.8 to 1:1.3; greater than 18 weight percent oxygen; and 0.3 to 4 weight percent boron.

### DETAILED DESCRIPTION

Unless otherwise indicated, numeric ranges, for instance “from 2 to 10,” are inclusive of the numbers defining the range (e.g., 2 and 10).

Unless otherwise indicated, ratios, percentages, parts, and the like are by weight.

Unless otherwise indicated, the crosslinkable functional group content for a polyolefin resin is characterized by the mol % crosslinkable functional groups, which is calculated as the number of mols of crosslinkable functional groups divided by the total number of mols of monomer units contained in the polyolefin.

Unless otherwise indicated, “monomer” refers to a molecule which can undergo polymerization, thereby contributing constitutional units to the essential structure of a macromolecule, for example, a polyolefin.

In one aspect, the present disclosure describes a process for producing a stabilized fabricated article from a polyolefin resin. Unless stated otherwise, any method or process steps described herein may be performed in any order. Polyolefins are a class of polymers produced from one or more olefin monomer. The polymers described herein may be formed from one or more types of monomers. Polyethylene is the preferred polyolefin resin, but other polyolefin resins may be substituted. For example, a polyolefin produced from ethylene, propylene, or other alpha-olefin (for instance, 1-butene, 1-hexene, 1-octene), or a combination thereof, is also suitable. The polyolefins described herein are typically provided in resin form, subdivided into pellets or granules of a convenient size for further melt or solution processing.

As described above, the polyolefin resin is processed to form a fabricated article. A fabricated article is an article which has been fabricated from the polyolefin resin. The fabricated article is formed using known polyolefin fabrication techniques, for example, melt or solution spinning to form fibers, film extrusion or film casting or a blown film process to form films, die extrusion or injection molding or compression molding to form more complex shapes, or solution casting. The fabrication technique is selected according to the desired geometry of the target stabilized article, and the desired physical properties of the same. For example, where the desired stabilized article is a carbon fiber, fiber spinning is a suitable fabrication technique. As another example, where the desired stabilized article is a carbon film, compression molding is a suitable fabrication technique.

The polyolefin resins described herein are subjected to a crosslinking step. In one instance, the polyolefin resins are crosslinked following formation of the fabricated article. Any suitable method for crosslinking polyolefins is sufficient. In one instance, the polyolefins are crosslinked by irradiation, such as by electron beam processing. Other crosslinking methods are suitable, for example, ultraviolet irradiation and gamma irradiation. In some instances, an initiator, such as benzophenone, may be used in conjunction with the irradiation to initiate crosslinking. In one instance, the polyolefin resins have been modified to include crosslinkable functional groups which are suitable for reacting to crosslink the polyolefin resin. Where the polyolefin resin includes crosslinkable functional groups, crosslinking may be initiated by known methods, including use of a chemical crosslinking agent, by heat, by steam, or other suitable method. In one instance, copolymers are suitable to provide a polyolefin resin having crosslinkable functional groups where one or more alpha-olefins have been copolymerized with another monomer containing a group suitable for serving as a crosslinkable functional group, for example, dienes, carbon monoxide, glycidyl methacrylate, acrylic acid, vinyl acetate, maleic anhydride, or vinyl trimethoxy silane (VTMS) are among the monomers suitable for being copolymerized with the alpha-olefin. Further, the polyolefin resin having crosslinkable functional groups may also be produced from a poly(alpha-olefin) which has been modified by grafting a functional group moiety onto the base polyolefin, wherein the functional group is selected based on its ability to subsequently enable crosslinking of the given polyolefin. For example, grafting of this type may be carried out by use of free radical initiators (such as peroxides) and vinyl monomers (such as VTMS, dienes, vinyl acetate, acrylic acid, methacrylic acid, acrylic and methacrylic esters such as glycidyl methacrylate and methacryloxypropyl trimethoxysilane, allyl amine, p-aminostyrene, dimethylaminoethyl methacrylate) or via azido-functionalized molecules (such as 4-[2-(trimethoxysilyl)ethyl)]benzenesulfonyl azide). Polyolefin resins having crosslinkable functional groups may be produced from a polyolefin resin, or may be purchased commercially. Examples of commercially available polyolefin resins having crosslinkable functional groups include SI-LINK sold by The Dow Chemical Company, PRIMACOR sold by The Dow Chemical Company, EVAL resins sold by Kuraray, and LOTADER AX8840 sold by Arkema.

As noted above, at least a portion of the polyolefin resin is crosslinked to yield a crosslinked fabricated article. In some embodiments, crosslinking is carried out via chemical crosslinking. Thus, in some embodiments, the crosslinked fabricated article is a fabricated article which has been treated with one or more chemical agents to crosslink the crosslinkable functional groups of the polyolefin resin having crosslinkable functional groups. Such chemical agent functions to initiate the formation of intramolecular chemical bonds between the crosslinkable functional groups or reacts with the crosslinkable functional groups to form intramolecular chemical bonds, as is known in the art. Chemical crosslinking causes the crosslinkable functional groups to react to form new bonds, forming linkages between the various polymer chains which define the polyolefin resin having crosslinkable functional groups. The chemical agent which effectuates the crosslinking is selected based on the type of crosslinkable functional group(s) included in the polyolefin resin; a diverse array of reactions are known which crosslink crosslinkable functional groups via intermolecular and intramolecular chemical bonds. A suitable chemical agent is selected which is known to crosslink the crosslinkable functional groups present in the fabricated article to produce the crosslinked fabricated article. For example, without limiting the present disclosure, if the crosslinkable functional group attached to the polyolefin is a vinyl group, suitable chemical agents include free radical initiators such as peroxides or azo-bis nitriles, for example, dicumyl peroxide, dibenzoyl peroxide, t-butyl peroctoate, azobisisobutyronitrile, and the like. If the crosslinkable functional group attached to the polyolefin is an acid, such as a carboxylic acid, or an anhydride, or an ester, or a glycidoxy group, a suitable chemical agent can be a compound containing at least two nucleophilic groups, including dinucleophiles such as diamines, diols, dithiols, for example ethylenediamine, hexamethylenediamine, butane diol, or hexanedithiol. Compounds containing more than two nucleophilic groups, for example glycerol, sorbitol, or hexamethylene tetramine can also be used. Mixed di- or higher-nucleophiles, which contain at least two different nucleophilic groups, for example ethanolamine can also be suitable chemical agents. If the crosslinkable functional group attached to the polyolefin is a mono-, di- or tri-alkoxy silyl group, water, and Lewis or Bronsted acid or base catalysts can be used as suitable chemical agents. For example, without limiting the present disclosure, Lewis or Bronsted acid or base catalysts include aryl sulfonic acids, sulfuric acid, hydroxides, zirconium alkoxides or tin reagents.

Crosslinking the fabricated article is generally preferred to ensure that the fabricated article retains its shape at the elevated temperatures required for the subsequent processing steps. Without crosslinking, polyolefin resins typically soften, melt or otherwise deform or breakdown at elevated temperatures. Crosslinking adds thermal stability to the fabricated article.

The crosslinked fabricated article is subjected to a stabilization step to yield a boron-treated stabilized fabricated article. In one instance, the fabricated article is treated with boron prior to the stabilization step. In one instance, the fabricated article is treated with boron during the stabilization step. The stabilization step comprises treating the crosslinked fabricated article in a heated environment with an oxidizing agent. In one instance the oxidizing agent is oxygen. In one instance, the stabilization step is conducted in air where the oxygen component of the air comprises the oxidizing agent. It is preferred that the oxidizing agent is continuously charged to the oven or other apparatus in which the stabilization process is executed to prevent depletion of the oxidizing agent and accumulation of by-products. In some embodiments, the temperature for stabilizing the crosslinked fabricated article is at least 120° C., preferably at least 190° C. In some embodiments, the temperature for stabilizing the crosslinked fabricated article is no more than 400° C., preferably no more than 300° C. In one instance, the crosslinked fabricated article is introduced to a heating chamber which is already at the desired temperature. In another instance, the fabricated article is introduced to a heating chamber at or near ambient temperature, which chamber is subsequently heated to the desired temperature. In some embodiments the heating rate is at least 1° C./minute. In other embodiments the heating rate is no more than 15° C./minute. In yet another instance, the chamber is heated step wise, for instance, the chamber is heated to a first temperature for a time, such as, 120° C. for one hour, then is raised to a second temperature for a time, such as 180° C. for one hour, and third is raised to a holding temperature, such as 250° C. for 10 hours. In one instance, the stabilization process involves holding the crosslinked fabricated article at the given temperature for periods up to 100 hours depending on the dimensions of the fabricated article. The stabilization process yields a boron-treated stabilized fabricated article. In one instance, the stabilized fabricated article is a precursor for a carbonaceous article. Without being limited by theory, the stabilization process oxidizes the crosslinked fabricated article and causes changes to the hydrocarbon structure that increases the crosslink density while decreasing the hydrogen/carbon ratio of the crosslinked fabricated article.

In one instance, the fabricated article is treated with boron prior to the stabilization step by introducing a boron-containing species (BCS) during the melt processing step used to form the fabricated article. In one instance, the BCS is added to the melt phase resin. In another instance, the BCS is introduced to the resin during the fabrication process. The polyolefin is treated with the BCS such that boron is contained in the fabricated article following fabrication. Any suitable BCS which deposits boron in the fabricated article may be used. In one instance, the BCS is an organoborane. In one instance, boric acid is used as the BCS. In one instance the BCS is a derivative of boric acid, for example, metaboric acid and boron oxide. In one instance, the BCS is a derivative of boronic acid, for example, a substituted boronic acid (for example, alkyl substituted, such as methyl-, or ethyl-, or aryl substituted, such as phenyl-). In one instance, the BCS is a derivative of borinic acid, for example, a substituted borinic acid (for example, alkyl substituted, such as methyl-, or ethyl-, or aryl substituted, such as phenyl-). In another instance, the BCS is a derivative of borane, boronic ester or boroxine. In one instance, the BCS is borate or a derivative thereof. In another instance, the BCS is elemental boron. In another instance, the BCS is a derivative of borazine, borohydride, or aminoborane.

In one instance, the fabricated article is treated with boron prior to the stabilization step by treating the fabricated article with a BCS that is suitable for crosslinking the fabricated article. In one instance, the polyolefin resins have been modified to include crosslinkable functional groups which are suitable for reacting in the presence of a BCS to crosslink the polyolefin resin. Any BCS suitable for initiating the formation of crosslinks in the polyolefin resin is suitable for use. Examples of suitable BCSs include borane, borate, borinic acid, boronic acid, boric acid, borinic ester, boronic ester, boroxine, aminoborane, borazine, borohydrides and derivatives and combinations thereof.

In one instance, boron treatment occurs during or intermediate to any of the following steps used to prepare a stabilized fabricated article: (a) providing an olefin resin, (b) forming a fabricated article from the olefin resin, (c) crosslinking the fabricated article to provide a crosslinked fabricated article, (d) stabilizing the crosslinked fabricated article by air oxidation to provide a stabilized fabricated article. In this instance, the boron is provided as a constituent of a liquid, for example, neat, in solution or in a dispersed phase. Examples of suitable boron-containing species include elemental boron, borane, borate, borinic acid, boronic acid, boric acid, borinic ester, boronic ester, boroxine, aminoborane, borazine, borohydrides and derivatives and combinations thereof. Examples of derivatives of boric acid include metaboric acid, and boron oxide. Examples of borate derivatives include inorganic borates such as zinc borate and organoborates such as tributyl borate.

In one instance, the fabricated article is treated with boron during the stabilization step by treating the crosslinked fabricated article with a BCS during stabilization. In one instance, the stabilization is performed in an atmosphere comprising air and a gas-phase BCS. Any suitable gas-phase BCS which deposits boron in the fabricated article may be used in the oxidizing environment. In one instance, boric acid is used as the BCS. In one instance a gaseous borate is used as the BCS, for example, trimethyl borate. In one instance the gaseous borate is a derivative of boric acid, for example, metaboric acid and boron oxide. In one instance, the gaseous borate is a derivative of boronic acid, for example, a substituted boronic acid (for example, alkyl substituted, such as methyl-, or ethyl-, or aryl substituted, such as phenyl-). In one instance, the gaseous borate is a derivative of borinic acid, for example, a substituted borinic acid (for example, alkyl substituted, such as methyl-, or ethyl-, or aryl substituted, such as phenyl-). In one instance, the gaseous borate is a derivative of borane, boronic ester, borinic ester, borohydride, aminoborane, borazine, or boroxine. In one instance, the BCS flows over the fabricated article. Unexpectedly, it has been found that the combination of treating with a BCS and stabilizing in an oxidizing environment improves mass retention of the stabilized fabricated article. Unexpectedly, it has been found that treating the fabricated article with a BCS, either prior to or during the stabilization step, improves mass retention of the stabilized article. It has also been found that treating the fabricated article with a boron-containing species improves form-retention of the stabilized article.

In another aspect, the present disclosure describes a boron-treated crosslinked fabricated article which is formed from a polyolefin precursor (resin). In one instance, the boron-treated crosslinked fabricated article is formed according to the process described herein.

In one instance, the present disclosure describes a crosslinked polyolefin article comprising: a carbon to hydrogen mol ratio of from 1:1.2 to 1:2.2; and 0.1 to 5 weight percent boron. In one instance, the carbon to hydrogen mol ratio is from 1:1.8 to 1:2.0. In one instance, the carbon to hydrogen mol ration is from 1:1.8 to 1:2.2. In one instance, the crosslinked polyolefin article has 0.5 to 5 weight percent boron. In one instance, the crosslinked polyolefin article has 1.0 to 5 weight percent boron. In one instance, the crosslinked polyolefin article has 2.0 to 5 weight percent boron.

In another aspect, the present disclosure describes a boron-treated stabilized fabricated article which is formed from a polyolefin precursor (resin). In one instance, the boron-treated stabilized fabricated article is formed according to the process described herein.

In one instance, the present disclosure describes a stabilized polyolefin article comprising: a carbon to hydrogen mol ratio of from 1:0.8 to 1:1.3; greater than 18 weight percent oxygen; and 0.3 to 4 weight percent boron. In one instance, the carbon to hydrogen mol ratio is from 1:0.8 to 1:1.0. In one instance, the carbon to hydrogen mol ratio is from 1:1.0 to 1:1.3. In one instance, the stabilized polyolefin article has 1 to 4 weight percent boron. In one instance, the stabilized polyolefin article has 2 to 4 weight percent boron. In one instance, the stabilized polyolefin article has 3 to 4 weight percent boron. In one instance, the stabilized polyolefin article has greater than 15 weight percent oxygen.

In one instance, the stabilized fabricated article is prepared from a crosslinked polyolefin fabricated article having 0 to 5.0 weight percent boron. In one instance, the composition of the stabilized fabricated article is prepared from a crosslinked polyolefin fabricated article having 0 to 4.0 weight percent boron. In one instance, the composition of the stabilized fabricated article is prepared from a crosslinked polyolefin fabricated article having 0 to 3.0 weight percent boron. In one instance, the composition of the stabilized fabricated article is prepared from a crosslinked polyolefin fabricated article having 0 to 2.0 weight percent boron. In one instance, the composition of the stabilized fabricated article is prepared from a crosslinked polyolefin fabricated article having 0 to 1.7 weight percent boron. In one instance, the composition of the stabilized fabricated article is defined as having 0-1 weight percent nitrogen.

In one instance, it is observed that a stabilized fabricated article which has been treated with boron during one or more of the fabrication steps (the treated stabilized article) has an increased mass yield as compared to a stabilized fabricated article which has not been treated with boron during one or more of the fabrication steps (the control stabilized article). It has been observed that the control stabilized article has an oxidation mass yield of 31 to 49 percent and an overall mass yield of 12 to 22 percent. It has been observed that the treated stabilized article has an oxidation mass yield of 57 to 84 percent and an overall mass yield of 30 to 47 percent. It is observed that the a stabilized fabricated article which has been treated with boron realizes a 71 to 84 percent improvement in oxidation mass yield relative to the control stabilized article. It is observed that the stabilized fabricated article which has been treated with boron realizes a 114 to 150 percent improvement in overall mass yield relative to the control stabilized article.

Some embodiments of the invention will now be described in detail in the following Examples.

In the Examples, overall mass yield is calculated as the product of oxidation mass yield and carbonization mass yield (calculated as provided below). PHR refers to parts per hundred resin (mass basis). MI refers to melt index which is a measure of melt flow rate. Wt % refers to parts per 100 total parts, mass basis. PE refers to polyethylene. BA refers to boric acid. Definitions of measured yields:

Oxidation mass yield:

$${Y}_{O} = \frac{{m}_{OX}}{{m}_{PE}}$$

Carbonization mass yield:

$${Y}_{C} = \frac{{m}_{CF}}{{m}_{OX}}$$

Overall mass yield: Y_{M}=Y_{O}Y_{C}
Overall mass yield (carbonaceous mass per initial mass of PE):

$${Y}_{M , PE} = \frac{{Y}_{O} {Y}_{C}}{{M}_{\% PE}}$$

Where m_{PE} is the initial mass of polyethylene; m_{OX} is the mass remaining after oxidation; m_{CF} is the mass remaining after carbonization; M_{% PE} is the mass % of polyethylene in the origin formed article.

Soxhlet extraction is a method for determining the gel content and swell ratio of crosslinked ethylene plastics. As used herein, Soxhlet extraction is conducted according to ASTM Standard D2765-11 “Standard Test Methods for Determination of Gel Content and Swell Ratio of Crosslinked Ethylene Plastics.” In the method employed, a crosslinked fabricated article between 0.050-0.500 g is weighed and placed into a cellulose-based thimble which is then placed into a Soxhlet extraction apparatus with sufficient quantity of xylenes. Soxhlet extraction is then performed with refluxing xylenes for at least 12 hours. Following extraction, the thimbles are removed and the crosslinked fabricated article is dried in a vacuum oven at 80° C. for at least 12 hours and then weighed, thereby providing a Soxhlet-treated article. The gel content (%) is then calculated from the weight ratio (Soxhlet-treated article)/(crosslinked fabricated article).

Precursor and oxidized films are submitted for elemental analysis to determine the carbon, hydrogen, oxygen, boron, and silicon content. A Thermo Model Flash EA1112 Combustion CHNS/O Analyzer is used for determining carbon, hydrogen, and oxygen components. Boron is detected by inductively coupled plasma atomic emission spectroscopy (ICP-AES) using a Perkin Elmer Optima 7300DV ICP atomic emission spectrometer. Silicon is determined by x-ray fluorescence (XRF).

### Example C1

An ethylene/octene copolymer (density=0.941 g/cm³; MI=34 g/10 min, 190° C./2.16 kg) is melt blended with Esacure ONE, a commercially available photoinitiator sold by Lambeth, at 2 wt % (2.04 phr) at 180° C. in a Haake mixer under nitrogen. Films are compression molded using a Carver press at 180° C. into thin films measuring 3 millimeters (76.2 microns) thick by micrometer. All films are crosslinked (30 s exposure time) using a 600 W/in H-type mercury UV lamp fitted with a parabolic (non-focused) reflector. Gel fraction is determined to be 35.5% by Soxhlet extraction. Composition of the untreated, crosslinked polyethylene film is reported in Table 17. Three (3) smaller circular films are sectioned from the prepared films and weighed. Films are oxidized in a convection oven at 250° C. for 10 hours under air environment (21% oxygen content). The three (3) films are weighed after air oxidation. Mass retention during air oxidation (oxidation mass yield) is reported in Table 1. Oxidized films are then carbonized in nitrogen environment from 25° C. to 800° C. using a ramp rate of 10° C./min. Mass retention during carbonization (carbonization mass yield) is reported in Table 1. Calculated overall mass yield is reported in Table 1. Composition of the untreated, stabilized polyethylene film is reported in Table 19 and Table 20.

TABLE 1

| | Oxidation Mass | Carbonization | Overall Mass |
|---|---|---|---|
| Example | Yield (%) | Mass Yield (%) | Yield (%) |
| A | 36.24 | 43.96 | 15.93 |
| B | 34.19 | 46.64 | 15.94 |
| C | 32.42 | 47.19 | 15.30 |

### Example P1A

An ethylene/octene copolymer (density=0.941 g/cm³; MI=34 g/10 min, 190° C./2.16 kg) is melt blended with Esacure ONE, a commercially available photoinitiator sold by Lamberti, at 2 wt % (2.04 phr) and boric acid (2.04 phr) at 180° C. in a Haake mixer under nitrogen. Films are compression molded using a Carver press at 180° C. into thin films measuring 3 millimeters (76.2 microns) thick by micrometer. All films are crosslinked (30 s exposure time) using a 600 W/in H-type mercury UV lamp fitted with a parabolic (non-focused) reflector. Composition of the treated polyethylene film is reported in Table 21, Table 23 and Table 24.

### Example P1B

An ethylene/octene copolymer (density=0.941 g/cm³; MI=34 g/10 min, 190° C./2.16 kg) is melt blended with Esacure ONE, a commercially available photoinitiator sold by Lamberti, at 2 wt % (2.04 phr) and boric acid (10.20 phr) at 180° C. in a Haake mixer under nitrogen. Films are compression molded using a Carver press at 180° C. into thin films measuring 3 millimeters (76.2 microns) thick by micrometer. All films are crosslinked (30 s exposure time) using a 600 W/in H-type mercury UV lamp fitted with a parabolic (non-focused) reflector. Composition of the treated polyethylene film is reported in Table 21, Table 23 and Table 24.

### Example P1C

An ethylene/octene copolymer (density=0.941 g/cm³; MI=34 g/10 min, 190° C./2.16 kg) is melt blended with Esacure ONE, a commercially available photoinitiator sold by Lambeth, at 2 wt % (2.04 phr) and boric acid (20.41 phr) at 180° C. in a Haake mixer under nitrogen. Films are compression molded using a Carver press at 180° C. into thin films measuring 3 millimeters (76.2 microns) thick by micrometer. All films are crosslinked (30 s exposure time) using a 600 W/in H-type mercury UV lamp fitted with a parabolic (non-focused) reflector. Composition of the treated polyethylene film is reported in Table 21, Table 23 and Table 24.

### Example S1A

The films prepared in Example HA are oxidized in a convection oven at 250° C. for 10 hours under air environment (21% oxygen content) to produce a stabilized film. Composition of the oxidized polyethylene film is reported in Table 22, Table 25 and Table 26. Oxidized films are then carbonized in nitrogen environment from 25° C. to 800° C. using a ramp rate of 10° C./min. Mass retention during oxidation (oxidation mass yield) and carbonization (carbonization mass yield) are reported in Table 2. Calculated overall mass yield is reported in Table 2.

TABLE 2

| | | | Overall | Overall |
|---|---|---|---|---|
| | Oxidation Mass | Carbonization | Mass | PE Mass |
| Example | Yield (%) | Mass yield (%) | Yield (%) | Yield (%) |
| A | 67.66 | 47.34 | 32.03 | 32.68 |
| B | 64.81 | 51.80 | 33.57 | 34.26 |

### Example S1B

The films prepared in Example P1B are oxidized in a convection oven at 250° C. for 10 hours under air environment (21% oxygen content) to produce a stabilized film. Composition of the oxidized polyethylene film is reported in Table 22, Table 25 and Table 26. Oxidized films are then carbonized in nitrogen environment from 25° C. to 800° C. using a ramp rate of 10° C./min. Mass retention during oxidation (oxidation mass yield) and carbonization (carbonization mass yield) are reported in Table 3. Calculated overall mass yield is reported in Table 3.

TABLE 3

| | Oxidation | Carbonization | Overall | Overall |
|---|---|---|---|---|
| | Mass | Mass | Mass | PE Mass |
| Example | Yield (%) | yield (%) | Yield (%) | Yield (%) |
| A | 83.45 | 47.85 | 39.93 | 44.01 |
| B | 75.74 | 43.77 | 33.15 | 36.53 |

### Example S1C

The films prepared in Example P1C are oxidized in a convection oven at 250° C. for 10 hours under air environment (21% oxygen content) to produce a stabilized film. Composition of the oxidized polyethylene film is reported in Table 22, Table 25 and Table 26. Oxidized films are then carbonized in nitrogen environment from 25° C. to 800° C. using a ramp rate of 10° C./min. Mass retention during oxidation (oxidation mass yield) and carbonization (carbonization mass yield) are reported in Table 4. Calculated overall mass yield is reported in Table 4.

TABLE 4

| | Oxidation | Carbonization | Overall | Overall |
|---|---|---|---|---|
| | mass | mass | Mass | PE Mass |
| Example | yield (%) | yield (%) | Yield (%) | Yield (%) |
| A | 77.35 | 50.82 | 39.31 | 47.33 |
| B | 78.17 | 45.82 | 35.82 | 43.13 |

### Example C2

An ethylene/octene copolymer (density=0.941 g/cm³; MI=34 g/10 min, 190° C./2.16 kg) is melt blended with Esacure ONE, a commercially available photoinitiator sold by Lambeth, at 2 wt % (2.04 phr) at 180° C. in a Haake mixer under nitrogen. Films are compression molded using a Carver press at 180° C. into thin films measuring 3 millimeters (76.2 microns) thick by micrometer. All films are crosslinked (30 s exposure time) using a 600 W/in H-type mercury UV lamp fitted with a parabolic (non-focused) reflector. Gel fraction is determined to be 27.9% by Soxhlet extraction. Composition of the untreated, crosslinked polyethylene film is reported in Table 17 and Table 18. Two (2) smaller circular films are sectioned from the prepared films and weighed. Films are oxidized in a convection oven at 270° C. for 5 hours under air environment (21% oxygen content). The two (2) films are weighed after air oxidation. Oxidized films are then carbonized in nitrogen environment from 25° C. to 800° C. using a ramp rate of 10° C./min Mass retention during oxidation (oxidation mass yield) and carbonization (carbonization mass yield) are reported in Table 5. Calculated overall mass yield is reported in Table 5. Composition of the untreated, stabilized polyethylene film is reported in Table 19 and Table 20.

TABLE 5

| | Oxidation Mass | Carbonization | Overall Mass |
|---|---|---|---|
| Example | Yield (%) | Mass Yield (%) | Yield (%) |
| A | 33.79 | 45.59 | 15.40 |
| B | 34.77 | 45.34 | 15.76 |

### Example P2

An ethylene/octene copolymer (density=0.941 g/cm³; MI=34 g/10 min, 190° C./2.16 kg) is melt blended with Esacure ONE, a commercially available photoinitiator sold by Lambeth, at 2 wt % (2.04 phr) and boric acid (30.61 phr) at 180° C. in a Haake mixer under nitrogen. Films are compression molded using a Carver press at 180° C. into thin films measuring 3 millimeters (76.2 microns) thick by micrometer. All films are crosslinked (30 s exposure time) using a 600 W/in H-type mercury UV lamp fitted with a parabolic (non-focused) reflector. Composition of the treated polyethylene film is reported in Table 21, Table 23 and Table 24.

### Example S2

The films prepared in Example P2 are oxidized in a convection oven at 270° C. for 5 hours under air environment (21% oxygen content) to produce a stabilized film. Composition of the oxidized polyethylene film is reported in Table 22, Table 25 and Table 26. Oxidized films are then carbonized in nitrogen environment from 25° C. to 800° C. using a ramp rate of 10° C./min. Mass retention during oxidation (oxidation mass yield) and carbonization (carbonization mass yield) are reported in Table 6. Calculated overall mass yield is reported in Table 6.

TABLE 6

| | Oxidation | Carbonization | Overall | Overall |
|---|---|---|---|---|
| | Mass | Mass | Mass | PE Mass |
| Example | Yield (%) | Yield (%) | Yield (%) | Yield (%) |
| A | 77.11 | 60.54 | 46.68 | 60.69 |
| B | 76.79 | 57.87 | 44.44 | 57.77 |

### Example C3

An ethylene/octene copolymer (density=0.941 g/cm³; MI=34 g/10 min, 190° C./2.16 kg) is reactive extruded with vinyl trimethoxysilane (VTMS) to form a VTMS-grafted ethylene/octene copolymer (MI=19 g/10 min, 190° C./2.16 kg; 1.4 wt % grafted silane content determined by ¹³C NMR) precursor resin. The VTMS-grafted precursor resin is melt spun to form fibers with the following properties: 1573 filaments, 1945.8 total denier, 2.25 gf/den, 12.17% elongation-to-break. The prepared fibers are continuously treated in a vessel containing an isopropanol solution with 5 wt % of an aryl sulfonic acid, Nacure B201 for 5 seconds. The treated fibers are allowed to dry cure for 3 days. The fibers are subsequently moisture cured at 80° C. (100% relative humidity) for 5 days. The gel fraction is determined to be 55.8-59.2% by Soxhlet extraction. Composition of the untreated, crosslinked polyethylene fibers are reported in Table 17 and Table 18. The untreated, crosslinked fibers are oxidized and carbonized using a Thermogravimetric Analysis (TGA) instrument using the conditions outlined in Table 7 with temperature ramp rates of 10° C./min Table 8 reports the mass retained during air oxidation and final mass yield after both oxidation and carbonization treatments.

TABLE 7

| | Oxidation (air) | | | |
|---|---|---|---|---|
| | | Isothermal | Carbonization (nitrogen) | |
| | Isothermal | Hold, | Starting | Final |
| | Hold, Time | Temperature | Temperature | Temperature |
| Segment | (hr) | (° C.) | (° C.) | (° C.) |
| 1 | 3 | 270 | 270 | 800 |
| 2 | 3 | 270 | 270 | 800 |

TABLE 8

| | Oxidation Mass | Overall Mass |
|---|---|---|
| Segment | Yield (%) | Yield (%) |
| 1 | 35.4 | 19.04 |
| 2 | 34.7 | 19.13 |

### Example P3

An ethylene/octene copolymer (density=0.941 g/cm³; MI=34 g/10 min, 190° C./2.16 kg) is reactive extruded with vinyl trimethoxysilane (VTMS) to form a VTMS-grafted ethylene/octene copolymer (MI=19 g/10 min, 190° C./2.16 kg; 1.4 wt % grafted silane content determined by ¹³C NMR) precursor resin. The VTMS-grafted precursor resin is melt spun to form fibers with the following properties: 1573 filaments, 1945.8 total denier, 2.25 gf/den, 12.17% elongation-to-break. The prepared fibers are continuously treated in a vessel containing an isopropanol solution with 5 wt % of an aryl sulfonic acid, Nacure B201 for 5 seconds. The treated fibers are allowed to dry cure for 3 days. The fibers are subsequently moisture cured at 80° C. (100% relative humidity) for 5 days. The gel fraction is determined to be 55.8-59.2% by Soxhlet extraction. The crosslinked fibers are subsequently treated with a 15 wt % solution of boric acid in methanol for 5 min. After the boric acid solution treatment, the fibers are dried overnight in air at ambient conditions. The dried, boric acid treated fibers undergo thermal treatment (80° C.) overnight in a vacuum oven. Composition of the treated polyethylene film is reported in Table 21, Table 23 and Table 24.

### Example S3

The fibers treated in Example P3 are oxidized and carbonized using a Thermogravimetric Analysis (TGA) instrument using the conditions outlined in Table 9 with temperature ramp rates of 10° C./min. Table 10 reports the mass retained during air oxidation and final mass yield after both oxidation and carbonization treatments.

TABLE 9

| | Oxidation (air) | | | |
|---|---|---|---|---|
| | | Isothermal | Carbonization (nitrogen) | |
| | Isothermal | Hold, | Starting | Final |
| | Hold, Time | Temperature | Temperature | Temperature |
| Segment | (hr) | (° C.) | (° C.) | (° C.) |
| 1 | 3 | 270 | 270 | 800 |
| 2 | 3 | 270 | 270 | 800 |

TABLE 10

| | Oxidation Mass | Overall Mass |
|---|---|---|
| Segment | Yield (%) | Yield (%) |
| 1 | 70.8 | 44.2 |
| 2 | 70.8 | 42.8 |

### Example P4

An ethylene/octene copolymer (density=0.941 g/cm³; MI=34 g/10 min, 190° C./2.16 kg) is reactive extruded with vinyl trimethoxysilane (VTMS) to form a VTMS-grafted ethylene/octene copolymer (MI=19 g/10 min, 190° C./2.16 kg; 1.4 wt % grafted silane content determined by ¹³C NMR) precursor resin. The VTMS-grafted precursor resin is melt spun to form fibers with the following properties: 1573 filaments, 1945.8 total denier, 2.25 gf/den, 12.17% elongation-to-break. Fiber tows are continuously treated in a vessel containing an isopropanol solution with 5 wt % of boric acid. Fiber residence time in the solution is 5 seconds. The treated fibers are allowed to dry cure for 3 days. The fibers are subsequently moisture cured at 80° C. (100% relative humidity) for 3 days. Gel fraction is determined to be 53.3% by Soxhlet extraction. The crosslinked fibers are subsequently treated with a 15 wt % solution of boric acid in methanol for 5 min After the boric acid solution treatment, the fibers are dried overnight in air at ambient conditions. The dried, boric acid treated fibers undergo thermal treatment (80° C.) overnight in a vacuum oven. Composition of the treated polyethylene film is reported in Table 21, Table 23 and Table 24.

### Example S4

The fibers treated in Example P3 are oxidized and carbonized using a Thermogravimetric Analysis (TGA) instrument using the conditions outlined in Table 11 with temperature ramp rates of 10° C./min. Table 12 reports the mass retained during air oxidation and final mass yield after both oxidation and carbonization treatments.

TABLE 11

| | Oxidation (air) | | | |
|---|---|---|---|---|
| | | Isothermal | Carbonization (nitrogen) | |
| | Isothermal | Hold, | Starting | Final |
| | Hold, Time | Temperature | Temperature | Temperature |
| Segment | (hr) | (° C.) | (° C.) | (° C.) |
| 1 | 5 | 270 | 270 | 800 |

TABLE 12

| Segment | Oxidation Mass Yield (%) | Overall Mass Yield (%) |
|---|---|---|
| 1 | 67.7 | 45.4 |

### Example C5

An ethylene/octene copolymer (density=0.941 g/cm³; MI=34 g/10 min, 190° C./2.16 kg) is melt blended with Esacure ONE, a commercially available photoinitiator sold by Lambeth, at 2 wt % (2.04 PHR) at 180° C. in a Haake mixer under nitrogen. Films are compression molded using a Carver press at 180° C. into thin films measuring 3 millimeters (76.2 microns) thick by micrometer. All films are crosslinked (30 s exposure time) using a 600 W/in H-type mercury UV lamp fitted with a parabolic (non-focused) reflector. Gel fraction is determined to be 35.5% by Soxhlet extraction. Nine (9) smaller circular films are sectioned from the prepared films and weighed. Composition of the untreated, crosslinked polyethylene film is reported Table 17 and Table 18. The films are oxidized in a convection oven at 270° C. for 5 hours under air (21% oxygen content). The nine (9) films are weighed after air oxidation. Mass retention during air oxidation (oxidation mass yield) is reported in Table 13. Oxidized films are then carbonized under nitrogen from 25° C. to 800° C. using a ramp rate of 10° C./min. Mass retention during carbonization (carbonization mass yield) is reported in Table 13. Calculated overall mass yield is reported in Table 13. Composition of the untreated, stabilized polyethylene film is reported in Table 19 and Table 20.

TABLE 13

| | Oxidation Mass | Carbonization | Overall Mass |
|---|---|---|---|
| Example | Yield (%) | Mass Yield (%) | Yield (%) |
| A | 32.50 | 50.22 | 16.32 |
| B | 31.11 | 48.04 | 14.94 |
| C | 33.39 | 45.25 | 15.11 |
| D | 34.80 | 44.44 | 15.46 |
| E | 47.29 | 25.86 | 12.23 |
| F | 32.39 | 44.20 | 14.32 |
| G | 33.97 | 41.32 | 14.03 |
| H | 34.49 | 39.94 | 13.77 |
| I | 30.64 | 50.86 | 15.58 |

### Example S5

An ethylene/octene copolymer (density=0.941 g/cm³; MI=34 g/10 min, 190° C./2.16 kg) is melt blended with Esacure ONE, a commercially available photoinitiator sold by Lambeth, at 2 wt % (2.04 PHR) at 180° C. in a Haake mixer under nitrogen. Films are compression molded using a Carver press at 180° C. into thin films measuring 3 millimeters (76.2 microns) thick by micrometer. Films are crosslinked (30 s exposure time) using a 600 W/in H-type mercury UV lamp fitted with a parabolic (non-focused) reflector. Gel fraction is determined to be 35.5% by Soxhlet extraction. Smaller circular films (A-H) are sectioned from the prepared films and weighed. The films are placed in a convection oven. A vessel containing boric acid is placed in the oven. The films are oxidized in the convection oven at 270° C. for 5 hours under air (21% oxygen content); a gaseous boron-containing species is generated in situ by heating boric acid in the oven. Composition of the oxidized polyethylene film is reported in Table 22, Table 25 and Table 26. Oxidized films are then carbonized under nitrogen from 25° C. to 800° C. using a ramp rate of 10° C./min Mass retention during oxidation (oxidation mass yield) and carbonization (carbonization mass yield) are reported in Table 14. Calculated overall mass yield is reported in Table 14.

TABLE 14

| | Oxidation Mass | Carbonization | Overall Mass |
|---|---|---|---|
| Example | Yield (%) | Mass Yield (%) | Yield (%) |
| A | 57.17 | 54.76 | 31.31 |
| B | 62.03 | 53.00 | 32.87 |
| C | 61.05 | 50.08 | 30.57 |
| D | 64.66 | 53.11 | 34.34 |
| E | 68.03 | 51.37 | 34.95 |
| F | 60.00 | 56.20 | 33.72 |
| G | 61.62 | 56.20 | 34.63 |
| H | 58.59 | 50.28 | 29.46 |

### Example C6

A vinyl trimethoxysilane-grafted ethylene/octene copolymer (MI=7 g/10 min, 190° C./2.16 kg; 1.6 wt % grafted silane content) is used as a precursor resin. Films are compression molded using a Carver press at 180° C. into thin films measuring 3 millimeters (76.2 microns) thick by micrometer. All films are crosslinked by treating the films with a commercial aryl sulfonic acid catalyst in isopropanol solution (Nacure B-201, King Industries) for 12 hours, followed by moisture curing at 60-80° C. for 72 hours. Gel fraction is determined to be 81.8% by Soxhlet extraction. Nine (9) smaller circular films are sectioned from the prepared film and weighed. Composition of the untreated, crosslinked polyethylene film is reported in Table 17 and Table 18. The films are oxidized in a convection oven at 270° C. for 5 hours under air (21% oxygen content). The nine (9) films are weighed after air oxidation. Mass retention during air oxidation (oxidation mass yield) is reported in Table 15. Oxidized films are then carbonized under nitrogen from 25° C. to 800° C. using a ramp rate of 10° C./min. Mass retention during carbonization (carbonization mass yield) is reported in Table 15. Calculated overall mass yield is reported in Table 15. Composition of the untreated, stabilized polyethylene film is reported in Table 19 and Table 20.

TABLE 15

| | Oxidation Mass | Carbonization | Overall Mass |
|---|---|---|---|
| Example | Yield (%) | Mass Yield (%) | Yield (%) |
| A | 43.50 | 51.01 | 22.19 |
| B | 42.19 | 43.59 | 18.39 |
| C | 41.58 | 50.52 | 21.00 |
| D | 43.81 | 45.03 | 19.73 |
| E | 45.31 | 42.46 | 19.24 |
| F | 40.26 | 52.07 | 20.96 |
| G | 43.87 | 43.11 | 18.91 |
| H | 49.09 | 42.74 | 20.98 |
| I | 41.85 | 41.13 | 17.21 |

### Example S6

A vinyl trimethoxysilane-grafted ethylene/octene copolymer (MI=7 g/10 min, 190° C./2.16 kg; 1.6 wt % grafted silane content) is used as a precursor resin. Films are compression molded using a Carver press at 180° C. into thin films measuring 3 millimeters (76.2 microns) thick by micrometer. All films are crosslinked by treating the films with a commercial aryl sulfonic acid catalyst in isopropanol solution (Nacure B-201, King Industries) for 12 hours, followed by moisture curing at 60-80° C. for 72 hours. Gel fraction is determined to be 81.8% by Soxhlet extraction. Smaller circular films (A-H) are sectioned from the prepared film and weighed. The films are placed in a convection oven. A vessel containing boric acid is placed in the oven. The films are oxidized in the convection oven at 270° C. for 5 hours under air (21% oxygen content); a gaseous boron-containing species is generated in situ by heating boric acid in the oven. Composition of the oxidized polyethylene film is reported in Table 22, Table 25 and Table 26. Oxidized films are then carbonized under nitrogen from 25° C. to 800° C. using a ramp rate of 10° C./min Mass retention during oxidation (oxidation mass yield) and carbonization (carbonization mass yield) are reported in Table 16. Calculated overall mass yield is reported in Table 16.

TABLE 16

| | Oxidation Mass | Carbonization | Overall Mass |
|---|---|---|---|
| Example | Yield (%) | Mass Yield (%) | Yield (%) |
| A | 61.94 | 55.77 | 34.55 |
| B | 62.23 | 52.71 | 32.80 |
| C | 60.88 | 53.29 | 32.44 |
| D | 61.03 | 50.54 | 30.85 |
| E | 61.96 | 51.19 | 31.72 |
| F | 60.25 | 50.58 | 30.47 |
| G | 62.52 | 49.97 | 31.24 |
| H | 61.47 | 52.90 | 32.52 |

### Example S7

An ethylene/octene copolymer (density=0.941 g/cm³; MI=34 g/10 min, 190° C./2.16 kg) is reactive extruded with vinyl trimethoxysilane (VTMS) to form a VTMS-grafted ethylene/octene copolymer (MI=19 g/10 min, 190° C./2.16 kg; 1.4 wt % grafted silane content determined by ¹³C NMR) precursor resin. The VTMS-grafted precursor resin is melt spun to form fibers with the following properties: 1573 filaments, 1945.8 total denier, 2.25 gf/den, 12.17% elongation-to-break. Fiber tows are continuously treated in a vessel containing an isopropanol solution with 5 wt % of boric acid. Fiber residence time in the solution is 5 seconds. The treated fibers are allowed to dry cure for 3 days. The fibers are subsequently moisture cured at 80° C. (100% relative humidity) for 1 day. Gel fraction is determined to be 42.9% by Soxhlet extraction. The boric acid solution treated precursor fibers are oxidized in the convection oven at 270° C. for 5 hours under air (21% oxygen content). Composition of the oxidized polyethylene fiber is reported in Table 22, Table 25 and Table 26.

The data in Tables 17 through 26 includes average values for a given Example where more than one article (film or fiber) was prepared in the given Example.

TABLE 17

| Comparative | | | | |
|---|---|---|---|---|
| Precursor | | | | |
| Example | C (wt %) | H (wt %) | O (wt %) | Si (wt %) |
| C1 | 85.5 | 14.1 | — | — |
| C2 | 85.6 | 14.1 | — | — |
| C3 | 86.9 | 14.5 | 1.3 | Not enough |
| | | | | sample |
| C5 | 85.6 | 14.1 | | — |
| C6 | 85.3 | 14.2 | 0.4 | 0.3 |

TABLE 18

| Comparative | | |
|---|---|---|
| Precursor | | |
| Example | C/H (wt/wt) | C/H (mol/mol) |
| C1 | 6.06 | 0.51 |
| C2 | 6.07 | 0.51 |
| C3 | 5.99 | 0.50 |
| C5 | 6.07 | 0.51 |
| C6 | 6.01 | 0.50 |

TABLE 19

| Comparative | | | | |
|---|---|---|---|---|
| Stabilized | | | | |
| Example | C (wt %) | H (wt %) | O (wt %) | Si (wt %) |
| C1 | 66.3 | 4.9 | 26.8 | — |
| C2 | 69.1 | 5.3 | 25.6 | — |
| C3 | N/A | N/A | N/A | N/A |
| C5 | 69.1 | 5.3 | 25.6 | — |
| C6 | 64.7 | 4.1 | 31.2 | 0.5 |

In Table 19, the Oxygen value for C2 and C5 was calculated by taking the difference of the Carbon value and Hydrogen value from 100 since there were no additives in the polyethylene. The other values are measured values.

TABLE 20

| Comparative | | | | |
|---|---|---|---|---|
| Stabilized | C/H | C/H | C/O | C/O |
| Example | (wt/wt) | (mol/mol) | (wt/wt) | (mol/mol) |
| C1 | 13.53 | 1.13 | 2.474 | 3.295 |
| C2 | 13.04 | 1.09 | 2.699 | 3.595 |
| C3 | N/A | N/A | N/A | N/A |
| C5 | 13.04 | 1.09 | 2.699 | 3.595 |
| C6 | 15.78 | 1.32 | 2.074 | 2.762 |

TABLE 21

| Precursor | | | |
|---|---|---|---|
| Example | C (wt %) | H (wt %) | B (wt %) |
| P1A | 83.8 | 14.0 | 0.25 |
| P1B | 79.3 | 13.6 | 1.06 |
| P1C | 71.0 | 12.5 | 1.6 |
| P2 | 71.4 | 12.4 | 3.8 |
| P3 | 79.9 | 13.6 | 1.6 |
| P4 | 71.8 | 12.6 | 3.0 |

TABLE 22

| Oxidized | | | | |
|---|---|---|---|---|
| Example | C (wt %) | H (wt %) | O (wt %) | B (wt %) |
| S1A | 65.9 | 4.5 | 25.2 | 0.44 |
| S1B | 71.7 | 7.8 | 18.7 | 0.76 |
| S1C | 66.0 | 5.8 | 24.3 | 1.0 |
| S2 | 60.6 | 5.1 | 21.1 | 3.5 |
| S5 | 66.2 | 4.5 | 28.9 | 0.39 |
| S6 | 69.2 | 5.4 | 22.0 | 0.28 |
| S7 | 64.2 | 5.8 | 18.8 | 2.2 |

TABLE 23

| Example | C/H (wt/wt) | C/B (wt/wt) |
|---|---|---|
| P1A | 5.986 | 335.200 |
| P1B | 5.831 | 74.811 |
| P1C | 5.680 | 44.375 |
| P2 | 5.758 | 18.789 |
| P3 | 5.875 | 49.938 |
| P4 | 5.698 | 23.933 |

TABLE 24

| Example | C/H (mol/mol) | C/B (mol/mol) |
|---|---|---|
| P1A | 0.502 | 301.683 |
| P1B | 0.489 | 67.331 |
| P1C | 0.476 | 39.938 |
| P2 | 0.483 | 16.911 |
| P3 | 0.493 | 44.944 |
| P4 | 0.478 | 21.540 |

TABLE 25

| Example | C/H (wt/wt) | C/O(wt/wt) | C/B (wt/wt) |
|---|---|---|---|
| S1A | 14.644 | 2.615 | 149.773 |
| S1B | 9.192 | 3.834 | 94.342 |
| S1C | 11.379 | 2.716 | 66.000 |
| S2 | 11.882 | 2.872 | 17.314 |
| S5 | 14.711 | 2.291 | 169.744 |
| S6 | 12.815 | 3.145 | 247.143 |
| S7 | 11.069 | 3.415 | 29.182 |

TABLE 26

| Example | C/H (mol/mol) | C/O (mol/mol) | C/B (mol/mol) |
|---|---|---|---|
| S1A | 1.228 | 3.483 | 134.797 |
| S1B | 0.771 | 5.107 | 84.909 |
| S1C | 0.954 | 3.618 | 59.401 |
| S2 | 0.996 | 3.826 | 15.583 |
| S5 | 1.233 | 3.051 | 152.771 |
| S6 | 1.074 | 4.190 | 222.431 |
| S7 | 0.928 | 4.549 | 26.264 |

What is claimed is:

1. A crosslinked polyolefin article comprising:
a carbon to hydrogen mol ratio of from 1:1.2 to 1:2.2; and
0.1 to 5 weight percent boron.

2. The crosslinked polyolefin article of claim 1, wherein the carbon to hydrogen mol ratio is from 1:1.8 to 1:2.0.

3. The crosslinked polyolefin article of claim 1, wherein the carbon to hydrogen mol ration is from 1:1.8 to 1:2.2.

4. The crosslinked polyolefin article of claim 1, and having 0.5 to 5 weight percent boron.

5. The crosslinked polyolefin article of claim 1, and having 1.0 to 5 weight percent boron.

6. The crosslinked polyolefin article of claim 1, and having 2.0 to 5 weight percent boron.

7. A stabilized polyolefin article comprising:
a carbon to hydrogen mol ratio of from 1:0.8 to 1:1.3;
greater than 18 weight percent oxygen; and
0.3 to 4 weight percent boron.

8. The stabilized polyolefin article of claim 7, wherein the carbon to hydrogen mol ratio is from 1:0.8 to 1:1.0.

9. The stabilized polyolefin article of claim 7, wherein the carbon to hydrogen mol ratio is from 1:1.0 to 1:1.3.

10. The stabilized polyolefin article of claim 7, and having 1 to 4 weight percent boron.

11. The stabilized polyolefin article of claim 7, and having 2 to 4 weight percent boron.

12. The stabilized polyolefin article of claim 7, and having 3 to 4 weight percent boron.

13. The stabilized polyolefin article of claim 7, and having greater than 15 weight percent oxygen.
